(19) United States
(12) Patent Application Publication
(10) Pub. No.: US 2005/0080917 A1
(43) Pub. Date: Apr. 14, 2005

(54) Radio link protocol control frame and radio link protocol sequence update method

(75) Inventor: Won Tae Choi, Ansan-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/942,051

(22) Filed: Sep. 16, 2004

(30) Foreign Application Priority Data
Oct. 13, 2003 (KR) 2003-71036

(51) Int. Cl. G06F 15/16; H04Q 7/20

(52) U.S. Cl. 709/232; 455/466

(57) ABSTRACT

Embodiments of present invention may provide an RLP control frame in a mobile communication system and/or an RLP sequence update method by which an RLP data frame having relatively less overhead than various type RLP data frames during high-speed data communications and by which an RLP reset may be minimized and/or reduced. Embodiments of the present invention may include performing a service negotiation with a peer RLP, performing an RLP sync procedure together with the peer RLP after completion of the service negotiation, transferring data frames reciprocally after completion of the RLP sync procedure, and deciding whether a transmission of a NAK control frame or a fill frame exists while a sequence of the transferred data frames increases to a previously set number. If the transmission fails to exist, the method may also include transferring a first RLP control frame for updating L_V(N) peer information of the peer RLP.

This application claims priority from Korean Application No. 2003-71036, filed Oct. 13, 2003, the subject matter of which is incorporated herein by reference.

### BACKGROUND OF THE INVENTION

1. Field of the Invention

Embodiments of the present invention may relate to a radio link protocol (RLP) control frame for high-speed data communications in a mobile communication system and/or a radio link protocol sequence update method. More particularly, embodiments of the present invention may relate to an RLP control frame and/or an RLP sequence update method by which an RLP data frame having relatively less overhead during high-speed data communications can be used and by which an RLP reset may be minimized.

2. Background of Related Art

Radio link protocol (RLP) is a protocol responsible for Layer-2 (L2) in an IS-2000 protocol stack on a premise of RLP type-3 based on the IS-707-A2 specification.

RLP is a ARQ protocol based on NAK to decrease error rates in data calls. RLP control frames and RLP data frames are provided based on the type of RLP frame. In the absence of control and data frames, RLP idle frames and RLP fill frames may be used.

In RLP control frames, frames may be responsible for RLP sync procedures in an RLP initial setup or reset. These may include a Sync frame, a Syncack frame, and an Ack frame as well as a NAK control frame used in NAK transmission.

In RLP data frames, there may be four kinds of formats, namely an RLP format-A and RLP format-B used for multiplex options 0×1, 0×2, 0×3, and 0×4 and an RLP format-C and an RLP format-D used for rest multiplex options.

The multiplex option of a packet data channel (PDCH) as a physical channel of the 1×EV-DV system may be 0×f00 so that an RLP format-C or an RLP format-D may be provided as an example. The RLP format-C may be configured similar to the following Table 1 and the RLP format -D may be configured similar to the following Table 2.

TABLE 1

| Field | Length (bits) |
|---|---|
| TYPE | 2 |
| SEQ | 8 |
| DATA | Variable |

The RLP format-C, as shown in Table 1, may be configured with a TYPE field of 2 bits indicating a form of the RLP format-C, a SEQ field of 8 bits indicating the least significant bits (LSB) of an RLP data frame sequence, and a DATA field having a variable length.

The RLP format-D, as shown in Table 2, may be configured with a TYPE field of 2 bits indicating a form of the RLP format-D, a SEQ field of 8 bits indicating the least significant bits of an RLP data frame sequence, an SSP field of 1-bit length, an SQI field of 1-bit length, a LAST_SEQ field of 1-bit length, a REXMIT field of 1-bit length, a LEN field of 0 or 8 bits length, an SEQ_HI field of 0 or 4 bits indicating the most significant bits of the RLP data frame sequence, an S_SEQ field of 0 or 12 bits length, a Padding_{—}1 field of variable length, a Data field, and a Padding_{—}2 field of variable length.

TABLE 2

| Field | Length |
|---|---|
| TYPE | 2 |
| SEQ | 8 |
| SSP | 1 |
| SQI | 1 |
| LAST_SEQ | 1 |
| REXMIT | 1 |
| LEN | 0 or 8 |
| SEQ_HI | 0 or 4 |
| S_SEQ | 0 or 12 |
| Padding_1 | Variable |
| Data | 8xLEN |
| Pading_2 | Variable |

Overhead of the RLP format-D may be greater than overhead of the RLP format-C. Hence, the RLP format-D may be appropriate for high-speed data.

In RLP, four 12-bit sequences such as L_V(S), L_V(N), LV(R), and L_V(N) peer may be given to frames to manage. L_V(S) may represent a number of data frames sent to a multiplex sublayer in a transmitting position. L_V(N) may represent a data frame number required for a sequentially later received position. L_V(R) may represent a number indicating a next new frame expected in a receiving side RLP position. L_V(N) peer may represent a sequence number estimating the L_V(N) of each relative RLP, which may be updated by a NAK control frame or a fill frame sent from the relative RLP.

There may be two major influences on the RLP performance by the L_V(N) peer information. First, if ‘{[L_V(S)+4096−L_V(N)peer] modulo 4096}>255’ is met by a decision of a presence or a non-presence of a necessity for SEQ_HI information, then the SEQ_HI information of 4-bits may be used. In this case, the RLP data format may be sent in a format-D form having an overhead relatively greater than an overhead of format-C. The RLP format-D may be transferred by adding an upper 4-bits of the L_V(S) called SEQ_HI under a decision that accurate data transmission is difficult with a sequence of the format-C transferring LSB 8-bits among 12-bits sequence of the L_V(S) only for the fast transmission. Consequently, this may transmit the entire 12-bits of the RLP sequence.

Secondly, the influence may relate to the RLP reset. If L_V(N) peer is greater then L_V(S), then RLP reset may occur. Once the RLP reset takes place, the entire sequences associated with the RLP such as L_V(S), L_V(R), L_V(N), and L_V(N) peer may be reset as well as the entire data frames stored in a buffer for retransmission, NAK list, and the like. Thus, if the reset occurs frequently, data throughout may be reduced.

However, the L_V(N) information may be carried only via the NAK control frame and the fill frame. This may result in failing to update the L_V(N) peer since the NAK control frame and the fill frame may hardly occur during downloading massive data under excellent (or good) radio environments. Moreover, in view of the RLP format using PDCH, the format-D having the greater overhead may be frequently used or the RLP reset may occur in high-speed data service under rapidly changing radio environments. The frequent use of the format-D and the RLP reset may occur more frequently in a system supporting high-speed data service sending RLP frames at a burst.

### SUMMARY OF THE INVENTION

Embodiments of the present invention may relate to an RLP control frame in a mobile communication system and/or an RLP sequence update method that substantially obviates one or more problems due to limitations and disadvantages of the related art.

Embodiments of the present invention may provide an RLP control frame in a mobile communication system and/or an RLP sequence update method by which an RLP data frame having relatively less overhead than other types of RLP data frames during high-speed data communications can be used and by which an RLP reset may be minimized.

An RLP sequence update method may be provided in a mobile communication system. This may include performing a service negotiation with a peer RLP and performing an RLP sync procedure together with a peer RLP after completion of the service negotiation. This may also include transferring data frames reciprocally after completion of the RLP sync procedures and deciding whether a transmission of a NAK control frame or a fill frame exists while a sequence to the transferred data frames increases to a previously set number. If the transmission of the NAK control frame or the fill frame fails to exist, the method may include transferring a first RLP control frame for updating L_V(N) peer information of the peer RLP. The RLP sequence update method may further include receiving a second RLP control frame corresponding to the first RLP control frame from the peer RLP based on the first RLP control frame.

Each of the first and second RLP control frames may include first information representing (or indicating) a type of a corresponding frame, second information representing (or indicating) L_V(N), third information representing (or indicating) presence or non-presence of a request for being provided with peer L_V(N), and fourth information for octet align. The third information may also relate to deciding whether to receive the second RLP control frame. A procedure may also be provided for negotiating with the peer RLP whether to perform the decision and/or the transferring of the first RLP control frame.

An RLP control frame may also be provided in a mobile communication system. This may include first information representing (or indicating) a type of a corresponding frame, second information representing (or indicating) L_V(N), third information representing (or indicating) presence or non-presence of a request for being provided with peer L_V(N), and fourth information for octet align, whereby L_V(N) peer information of a peer RLP may be updated.

Additional advantages, objects, features and embodiments of the present invention may be set forth in part in the description that follows and in part may become apparent to those having ordinary skill in the art upon examination of the following or may be learned from practice of the invention. The objectives and other advantages of the invention may be realized and attained by the structure particularly pointed out in the written description as well as the appended drawing.

It is to be understood that both the foregoing description and the following detailed description are merely exemplary as other embodiments, structures, frames and methods are also within the scope of the present invention.

### BRIEF DESCRIPTION OF THE DRAWING

The accompanying drawing may provide a further understanding of embodiments of the invention and is incorporated in and constitutes a part of this application.

FIG. 1 is a flow chart of an RLP sequence update method in a mobile communication system according to an example embodiment of the present invention.

### DETAILED DESCRIPTION OF PREFERRED EMBODIMENTS

An RLP control frame in a mobile communication system and an RLP sequence update method will now be described.

Embodiments of the present invention may provide an RLP control frame that transmits a current L_V(N) if a specific condition is met so as to maintain L_V(N) peer with the latest information. For example, the L_V(N) may be transmitted if a NAK control frame fails to occur while a sequence number of a transmitted data frame increases up to a predetermined number smaller than 255. If the previously set specific condition is met, then a 12-bit sequence of a current L_V(N) may be provided on the RLP control frame to be transmitted to a relative system (peer) so that the L_V(N) peer information of the relative system can be updated. The RLP control frame may hereafter be called a sequence update control frame.

The sequence update control frame according to an example embodiment of the present invention may be configured as set forth in the following Table 3.

TABLE 3

| Field | Length (bits) |
|---|---|
| TYPE | 6 |
| SEQ | 12 |
| SEQ_REQ | 1 |
| Padding | Variables |

In Table 3, the sequence update control frame may include a TYPE field representing (or indicating) a type of a corresponding frame. That is, this field may include 6-bit data such as ‘010010’. The sequence update control frame may also include an SEQ field of 12 bits representing (or indicating) L_V(N) information, a SEQ_REQ field of 1 bit representing (or indicating) whether to receive current L_V(N) information of a peer from a peer system, and a Padding field of variable length representing (or indicating) information for octet align.

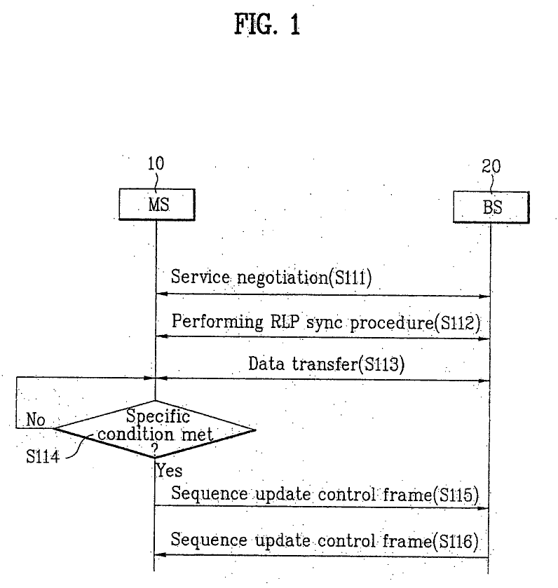

If a format type of a data frame transmitted or received by an RLP layer is ‘C’ and if a NAK control frame (or a fill frame) is not transmitted while a sequence of the transmitted/received data frame increases up to a predetermined number (e.g., ‘150’), then it may be determined that the previously set specific condition is met and the corresponding RLP layer may then transmit the sequence update control frame to the peer. The peer having received the sequence update control frame may update its L_V(N) peer of a 12-bit sequence based on the L_V(N) information in the SEQ field of the received sequence update control frame and transmit a next new/retransmission data frame. This procedure may be explained with reference to FIG. 1.

FIG. 1 is a flow chart of an RLP sequence update method in a mobile communication system according to an example embodiment of the present invention. Other operations, orders of operations and embodiments of the present invention are also with the scope of the present invention. More specifically, FIG. 1 shows communications between a mobile station (hereafter MS) 10 and a base station (hereafter BS) 20 as one example.

In FIG. 1, a negotiation for a data service is performed between the MS 10 and the BS 20 in a peer system for the MS 10. After completion of the service negotiation in operation S111, an RPL sync procedure may be performed in operation S112 between an RLP of the MS 10 and an RLP of the BS 20. After completion of the RLP sync procedure, data frames may be transferred between the MS 10 and the BS 20 in operation S113.

After operation S113, the MS 10 may decide in operation S114 whether a specific condition is met. For example, operation S114 may involve deciding whether a transmission exists of a NAK control frame or a fill frame up until a point when a number of the transferred data frames has increased to a previously set number (e.g., ‘150’). That is, the MS 10 may decide whether a previously set specific condition is met or not in operation S114.

If the previously set specific condition is not met, then the MS 10 may keep performing operation S113 (i.e., the data transfer). If the previously set specific condition is met, then the MS 10 may generate a sequence update control frame configured similar to Table 3 to update L_V(N) peer information of the RLP of the BS 20 and then transfer the generated sequence update control frame to the BS 20. The BS 20 then may update its corresponding L_V(N) peer information based on L_V(N) information recorded in a SEQ field of the received sequence update control frame in operation S115.

The BS 20 may decide whether to provide its L V(N) information to the MS 10 based on the 1-bit information recorded in a SEQ_REQ field of the received sequence update control frame. For example, if the 1-bit information is ‘1’, the BS 20 may provide its L_V(N) information to the MS 10. If the 1-bit information is ‘0’, the BS 20 may not provide its L_V(N) information to the MS 10. Therefore, if the 1-bit information recorded in the SEQ_REQ field of the received sequence update control frame is ‘1’, then the BS 20 may transfer the sequence update control frame configured similar to Table 3 to the MS 10. The MS 10 may then update its corresponding LV(N) peer information based on the L_V(N) information recorded in the SEQ field of the received sequence update control frame in operation S116.

A continuously incrementing number (e.g., 150) of data frames for determining a time point of transferring the sequence update control frame according to an example embodiment of the present invention may be smaller than ‘255’ in the expression of ‘{[L_V(S)+4096−L_V(N)peer] modulo 4096}>255’ by which the peer may decide the presence or non-presence of a necessity for ‘SEQ_HI’. By considering air and network delays, the continuous increment number may be decided as ‘150’ in an example embodiment of the present invention. However, this number may be optimized based on various conditions, such as network environment.

If an extended channel indicator is ‘1’ or ‘2’, then the sequence update control frame may be transferred as a fundamental channel (FCH) or a dedicated control channel (DCH) in a reverse direction or a packet data channel (PDCH) in a forward direction. If the extended channel indicator is equal to or greater than ‘3’, then the sequence update control frame may be transferred via FCH or DCCH in both the forward and reverse directions.

The sequence update control frame may work as an overhead on the system. In call setup, the decision whether to support the sequence update control frame may be reciprocally negotiated between the RLPs of the MS 10 and the BS 20 during the service negotiation such as operation S111 in FIG. 1. That is, an SEQ_UPT_FR_SUPPORT field for recording whether to support the sequence update control frame may be provided in an RLP BLOB frame shown in Table 4, for example, and 1-bit flag information may then be recorded in the corresponding field. Thus, the sequence update control frame may be defined to be used only if the recorded flag information is ‘TRUE’.

TABLE 4

| Field | Length (bits) |
|---|---|
| RLP_BLOB_TYPE | 3 |
| RLP_VERSION | 3 |
| RTT | 0 or 4 |
| INT_VAR | 1 |
| BS_EXT_SEQ_M | 0 or 18 |
| MS_EXT_SEQ_M | 0 or 18 |
| MAX_MS_NAK_ROUND_FWD | 0 or 3 |
| MAX_MS_NAK_ROUND_REV | 0 or 3 |
| NAK_ROUNDS_FWD | 3 |
| NAK_ROUNDS_REV | 3 |
| NAK_PER_ROUND_FWD | 3 |
| NAK_PER_ROUND_REV | 3 |
| SEQ_UPT_FR_SUPPORT | 1 |

Embodiments of the present invention may have several effects and/or advantages. For example, the format (RLP format-C on PDCH, RLP format-B on FCH) for which SEQ_HI is unnecessary may be enabled to continue transmission under excellent radio environment, whereby the RLP data frame having relatively less overhead can be used. It may also prevent the RLP reset by the NAK incoming at burst under an environment that rapidly changes the intensity of radio waves.

It will be apparent to those skilled in the art that various modifications and variations may be made in embodiments of the present invention. Thus, it is intended that embodiments of the present invention may cover modifications and variations of this invention.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

1. A radio link protocol (RLP) sequence update method in a mobile communication system, comprising:
performing a service negotiation with a peer RLP;
performing an RLP sync procedure with the peer RLP;
transferring data frames; and
determining whether a transmission occurs of a NAK control frame or a fill frame during the transferring of the data frames.

2. The RLP sequence method of claim 1, wherein the determining occurs while a number of transferred data frames is below a set number.

3. The RLP sequence update method of claim 2, wherein the set number is equal to or smaller than 255.

4. The RLP sequence update method of claim 1, wherein if the transmission is determined not to have occurred, the method further comprises transferring a first RLP control frame to the peer RLP.

5. The RLP sequence update method of claim 4, wherein the first RLP control frame provides updating peer information to the peer RLP.

6. The RLP sequence update method of claim 4, further comprising receiving a second RLP control frame corresponding to the first RLP control frame from the peer RLP based on the first RLP control frame.

7. The RLP sequence update method of claim 6, wherein the first RLP control frame comprises first information representing a type of a corresponding frame, second information representing L_V(N), third information representing presence or non-presence of a request for being provided with peer L_V(N), and fourth information for octet align.

8. The RLP sequence update method of claim 7, further comprising deciding whether to receive the second RLP control frame based on the third information.

9. The RLP sequence update method of claim 4, wherein the first RLP control frame is transferred via a fundamental channel (FCH) in a reverse direction or via a packet data channel (PDCH) in a forward direction.

10. The RLP sequence update method of claim 4, wherein the first RLP control frame is transferred via a dedicated control channel (DCCH) in a reverse direction or via a packet data channel (PDCH) in a forward direction.

11. The RLP sequence update method of claim 4, wherein the first RLP control frame is transferred via a fundamental channel (FCH) in a reverse direction and a forward direction.

12. The RLP sequence update method of claim 4, wherein the first RLP control frame is transferred via a dedicated control channel (DCCH) in a reverse direction and a forward direction.

13. The RLP sequence update method of claim 4, wherein performing the service negotiation includes negotiating with the peer RLP whether to transfer the first RLP control frame.

14. The RLP sequence update method of claim 13, wherein performing the service negotiating involves carrying information of presence or non-presence of supporting the deciding of transferring the RLP control frame in an RLP BLOB frame.

15. The RLP sequence update method of claim 1, wherein performing the RLP sync procedure is performed after completion of the service negotiation.

16. The RLP sequence update method of claim 1, wherein transferring the data frames occurs after completion of the RLP sync procedure.

17. A radio link protocol (RLP) sequence update method comprising:
transferring data frames from a first entity to a second entity;
determining whether a control frame or a full frame has been transmitted from the first entity to the second entity; and
transferring a first RLP control frame if it is determined that the control frame or the fill frame has not been transmitted.

18. The RLP sequence update method of claim 17, wherein the determining occurs while a number of transferred data frames is below a predetermined number.

19. The RLP sequence update method of claim 17, wherein the first RLP control frame provides updating peer information to the second entity.

20. The RLP sequence update method of claim 17, further comprising receiving a second RLP control frame corresponding to the first RLP control frame from the second entity based on the first RLP control frame.

21. The RLP sequence update method of claim 20, wherein the first RLP control frame comprises first information representing a type of a corresponding frame, second information representing L_V(N), third information representing presence or non-presence of a request for being provided with L_V(N), and fourth information for octet align.

22. The RLP sequence update method of claim 21, further comprising deciding whether to receive the second RLP control frame based on the third information.

23. The RLP sequence update method of claim 17, wherein performing the service negotiation includes negotiating with the second entity whether to transfer the first RLP control frame.

24. The RLP sequence update method of claim 23, wherein the performing the service negotiating is performed by carrying information of presence or non-presence of supporting the deciding of transferring the RLP control frame in an RLP BLOB frame.

25. An RLP control frame in a mobile communication system comprising:
first information representing a type of a corresponding frame;
second information representing L_V(N);
third information representing presence or non-presence of a request for being provided with peer L_V(N); and
fourth information for octet align, whereby L_V(N) peer information of a peer RLP is updated.

26. The RLP control frame of claim 25, wherein the first information includes a TYPE field having a length of 6 bits.

27. The RLP control frame of claim 25, wherein the second information includes an SEQ field having a length of 12 bits.

28. The RLP control frame of claim 25, wherein the third information includes an SEQ_REQ field having a length of 1 bit.

29. The RLP control frame of claim 25, wherein the fourth information includes a Padding field having a variable length.
